(19) United States
(12) Patent Application Publication
(10) Pub. No.: US 2025/0323367 A1
(43) Pub. Date: Oct. 16, 2025

(54) BATTERY SYSTEM WITH IMPROVED END PLATE

(71) Applicant: SAMSUNG SDI CO., LTD., Yongin-si (KR)

(72) Inventor: Martin BLODER, Sinabelkirchen (AT)

(21) Appl. No.: 18/886,536

(22) Filed: Sep. 16, 2024

(30) Foreign Application Priority Data
Apr. 10, 2024 (EP) 24169459.5

(51) Int. Cl. H01M 50/242; H01M 50/249; H01M 50/262; H01M 50/276

(52) U.S. Cl. CPC H01M 50/242; H01M 50/262; H01M 50/276; H01M 50/249

(57) ABSTRACT

A battery system includes: a cell stack including a plurality of battery cells arranged along a stacking axis; and a cell stack frame accommodating the cell stack. The cell stack frame includes: a displaceable end plate including a plate element facing the cell stack and mounting elements at opposite sides of the plate element. The plate element is mounted to side walls of the cell stack frame via the mounting elements. Each of the mounting elements is connected to the plate element via a plurality of deformable arms configured to allow displacement of the plate element along the stacking axis, and the plate element, under a deformation of the deformable arms, exerts pressure onto the cell stack.

### CROSS REFERENCE TO RELATED APPLICATION

The present application claims priority to and the benefit of European Patent Application Ser. No. 24/169,459.5, filed on Apr. 10, 2024, in the European Patent Office, the entire disclosure of which is incorporated herein by reference.

### BACKGROUND

### 1. Field of the Disclosure

Aspects of embodiments of the present disclosure relate to a battery system with an improved end plate.

### 2. Description of the Related Art

Recently, vehicles for transportation of goods and peoples have been developed that use electric power as a source for motion. Such an electric vehicle is an automobile that is propelled, permanently or temporarily, by an electric motor using energy stored in rechargeable batteries. An electric vehicle may be solely powered by batteries (a so-called Battery Electric Vehicle or BEV) or may include a combination of an electric motor and, for example, a conventional combustion engine (a so-called Plugin Hybrid Electric Vehicle or PHEV). BEVs and PHEVs use high-capacity rechargeable batteries that are designed to provide power for propulsion over sustained periods of time.

Generally, a rechargeable (or secondary) battery cell includes an electrode assembly including a positive electrode, a negative electrode, and a separator interposed between the electrodes. A solid or liquid electrolyte allows for movement of ions during charging and discharging of the battery cell. The electrode assembly is located (or arranged) in a casing and electrode terminals, which are positioned on the outside of the casing, establish an electrically conductive connection to the electrodes. The casing may have, for example, a cylindrical or rectangular shape.

A battery module is generally formed of a plurality of battery cells connected together in series or in parallel. For example, the battery module is formed by interconnecting the electrode terminals of the plurality of battery cells in a number and configuration depending on a desired amount of power and to provide a high-power rechargeable battery.

Battery modules can be constructed in either a block design or in a modular design. In the block design, each battery cell is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include a plurality of battery modules connected together in series to provide a desired voltage.

A battery pack is a set of any number of (usually identical) battery modules or single battery cells. The battery modules, or the respective battery cells, may be configured in a series, parallel, or a mixture of both to provide the desired voltage, capacity, and/or power density. Components of a battery pack include the individual battery modules and interconnects, which provide electrical conductivity between the battery modules.

The battery cells of a battery pack may be arranged to form a cell stack by stacking the battery cells onto each other or by arranging the battery cells in a row. Neighboring battery cells in a cell stack may be distanced (or spaced apart) from one another via cell spacers. The cell stack may be placed inside a cell stack frame delimiting the battery cells to the outside. Pressure (e.g., predefined pressure) is exerted onto the battery cells by the cell stack frame to compensate for possible production tolerances and swelling of the battery cells to ensure optimal operation of the battery cells over their lifetime.

Conventional battery systems generally include cell stack frames with end plates exerting pressure onto the cell stack with a rigid linear or progressive elastic pressure characteristic. Such rigid frameworks may be susceptible to length or positioning deviations because a small displacement may cause a large (or steep) increase or decrease of force applied onto the cell stack, which may, in turn, reduce the performance of the call stack. To mitigate this, very precise and, therefore, expensive production tolerances have to be met or other costly and intricate ways of adjusting the cell stacks pre-tension via positioning of the end plate during assembly have to be implemented. Such end plates may not be able to ensure that the right amount of pressure is applied to the cell stack over its entire lifetime.

### SUMMARY

The present disclosure is defined by the appended claims and their equivalents. The description that follows is subject to this limitation. Any disclosure lying outside the scope of the claims and their equivalents is intended for illustrative as well as comparative purposes.

According to embodiments of the present application, a battery system with an improved cell stack frame is provided that ensures correct pressure conditions for optimal operation of the battery cells over their entire lifetime.

According to an embodiment of the present disclosure, a battery system includes: a cell stack including a plurality of battery cells arranged along a stacking axis; and a cell stack frame accommodating the cell stack. The cell stack frame includes: a displaceable end plate including a plate element facing the cell stack and mounting elements at opposite sides of the plate element. The plate element is mounted to side walls of the cell stack frame via the mounting elements. Each of the mounting elements is connected to the plate element via a plurality of deformable arms configured to allow displacement of the plate element along the stacking axis, and the plate element, under a deformation of the deformable arms, exerts pressure onto the cell stack.

Each of the deformable arms may include a plurality of arm elements, and two adjacent ones of the arm elements may be separated from one another by a slit.

The deformable arms of each of the mounting elements may protrude at opposite sides of the corresponding one of the mounting elements.

The displaceable end plate may include a plurality of plate elements arranged one above the other, and the plate elements may face the cell stack in a common plane.

A bent connector element may be arranged between neighboring ones of the plate elements to interconnect the neighboring ones of the plate elements, and the bent connector element may be bent backwards away from the cell stack along the stacking axis.

The plate element, the deformable arms, and the mounting elements of the displaceable end plate may be formed as one-piece from a sheet material.

The displaceable end plate may be formed as one-piece from a sheet metal.

Each of the mounting elements may connected to the plate element via connecting portions having a thickness equal to or thicker than a thickness of the deformable arms.

The battery system may further include two displaceable end plates. One of the displaceable end plates may be at opposite ends of the cell stack frame.

Another embodiment of the present disclosure provides an electric vehicle including the battery system as described above.

Further aspects and features of the present disclosure can be learned from the dependent claims and/or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a schematic top view of a battery system according to an embodiment.

FIGS. 2A-2D are a perspective view, a front view, a side view, and a top view of a displaceable end plate of the battery system according to an embodiment.

FIGS. 3A-3D illustrate a perspective view, a front view, a side view, and a top view of a displaceable end plate of the battery system according to another embodiment.

FIGS. 4A-4C are schematic top views of battery systems having different cell stack lengths and corresponding side views of the displaceable end plate of the battery systems.

FIG. 5 is a diagram showing a force to elongation (e.g., displacement) ratio for the battery system according to an embodiment.

### DETAILED DESCRIPTION

Reference will now be made, in detail, to embodiments, examples of which are illustrated in the accompanying drawings. Aspects and features of the embodiments, and implementation methods thereof, will be described with reference to the accompanying drawings. The present disclosure, however, may be embodied in various different forms and should not be construed as being limited to the embodiments illustrated herein. Rather, these embodiments are provided as examples so that this disclosure will be thorough and complete and will fully convey the aspects and features of the present disclosure to those skilled in the art.

Accordingly, processes, elements, and techniques that are not considered necessary for those having ordinary skill in the art to have a complete understanding of the aspects and features of the present disclosure may not be described or may be only briefly described.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

As used herein, the term “substantially,” “about,” and similar terms are used as terms of approximation and not as terms of degree and are intended to account for inherent deviations in measured or calculated values that would be recognized by those of ordinary skill in the art. Further, if the term “substantially” is used in combination with a feature that could be expressed using a numeric value, the term “substantially” denotes a range of +/−5% of the value centered on the value.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

According to an embodiment of the present disclosure, a battery system includes a plurality of battery cells, for example, prismatic or pouch type battery cells. The battery cells are arranged to form a cell stack, for example, by being stacked onto each other or by being arranged in a row along a stacking axis. Cell spacers may be disposed in-between adjacent or neighboring battery cells. Thus, neighboring battery cells of the cell stack may be distanced (or spaced) from one another via the cell spacer. The cell stack may form one or more battery packs.

The cell stack is disposed inside a cell stack frame. The cell stack frame includes at least one displaceable end plate. The cell stack frame may include, for example, two end plates and two side walls connecting the end plates. One or both of the end plates may be a displaceable end plates. The cell stack arranged inside the cell stack frame may, thus, be delimited from four sides by the end plates and side walls. The cell stack frame may further include a top cover and a bottom cover such that the cell stack may be delimited from all six sides. The displaceable end plate is fixed to the side walls, for example, by being riveted or screwed, via its mounting elements. The cell stack frame may delimit the cell stack to an outside, for example, from an external environment. The displaceable end plate may form an outer delimitation of the cell stack frame. Also, the other end plate and/or the side walls may form the outer delimitation of the cell stack frame. For example, the cell stack frame may delimit an interior space of the cell stack frame from the exterior with the cell stack arranged in the interior space. One or both of the end plates may be displaceable end plates.

The displaceable end plate includes a plate element, which faces the cell stack. The plate element may contact the cell stack directly or via, for example, an end spacer. The plate element is the plate-shaped part of the displaceable end plate. The plate element may be substantially rigid, for example, non-deformable. The plate element may have a shape and size corresponding to a shape and size of the interior of the cell stack frame. The plate element, and, thus, the displaceable end plate, is attached to the side walls of the cell stack frame via the mounting elements. For example, the displaceable end plate includes mounting elements connected to the plate element, and the mounting elements are attached to the side walls by, for example, being riveted or screwed. A first mounting element may be connected to a first end of the plate element next to a first side wall of the cell stack frame, and a second mounting element may be connected to a second end of the plate element next to a second side wall of the cell stack frame opposite the first side wall. The displaceable end plate may be mounted to the side walls at a pre-defined fixture/mounting position with respect to the side walls. Each of the mounting elements is connected to the plate element via two or more deformable arms. The deformable arms are deformable such that the plate element may be displaced (or moved) along the stacking axis of the battery cells of the cell stack.

During assembly of the battery system, the displaceable end plate is placed at the end of the cell stack frame such that the plate element is pressed against the cell stack. Thereby, the deformable arms are deformed and the plate element is displaced. For example, the deformable arms are tensioned, thereby exerting force/pressure onto the plate element, and the plate element in turn exerts force/pressure onto the cell stack. Thus, the displaceable end plate exerts pressure onto the cell stack via the plate element. The plate element of the displaceable end plate is pressed against the cell stack with a pressing force, and the displaceable end plate is supported by the side walls of the cell stack frame via its mounting elements. For example, the side walls of the cell stack frame may act as a counter-bearing surfaces such that the plate element is spring-loaded against the cell stack via the deformable arms.

The deformable arms are configured to be, at lower compression forces, elastically deformed and, at higher compression forces, plastically deformed. In other words, the displaceable end plate may be configured, due to its deformable arms, to deform linearly elastic in a first force range and linearly plastic in a second force range. The displaceable end plate with its plate element being supported by the deformable arms may exhibit suitable deformation characteristic to ensure that the pressure applied onto the cell stack, for example, the compression force acting onto the cell stack, is substantially constant over the lifetime of the cell stack. Thus, in contrast to conventional battery systems, which may exhibit a rigid linear or progressive elastic pressure characteristic, the battery system according to embodiments of the present disclosure has, due to the displaceable end plate, a constant deformation characteristic in the relevant force range. For example, the displaceable end plate may exert a constant compression force onto the cell stack in the relevant pre-tensioning force range for prismatic or pouch type cells. Inevitable tolerances for both the elements of the cell stack as well as the elements of the cell stack frame can be compensated for by the deformation ability of the displaceable end plate, which may eliminate the need of additional shimming or other adjustment work during cell stacking. Further, any swelling (which may be due to, for example, ageing) of the battery cells of the cell stack may also be compensated. Also, loads which may occur during accidents may be compensated. Due to said tolerances and swelling, a length of the cell stack may vary. However, the displaceable end plate may exert substantially the same pressure onto the cell stack independent of the length of the cell stack. Thus, the cell stack may be maintained in the optimum range of pressure for peak performance ensuring reliable and safe operation through all its life cycle until end of life. Due to the deformable arms, the displaceable end plate may always be mounted at the same fixture position without adjustments while keeping the pressure onto the cell stack within the desired range. Thus, in summary, the battery system is configured to compensate for production tolerances as well as swelling forces/displacements of the battery cells over the lifetime of the battery system because the displaceable end plate is configured to maintain a substantially constant pressure.

According to an embodiment, each of the deformable arms includes two or more arm elements, and neighboring arm elements are separated from one another by a slit. The arm elements may extend parallel to each other. The slits may be formed as through-slits, for example, they may form openings extending through the material. For example, each of the deformable arms may include three arm elements and two slits, with the arm elements and slits being arranged alternately. Providing multiple arm elements may improve the deformability of the deformable arms and may ensure that the displaceable end plate/the deformable arms exhibit the intended deformation characteristic.

According to an embodiment, for each mounting element, the deformable arms protrude from the mounting element at opposite sides of the mounting element. The deformable arms may protrude upwardly/downwardly from the mounting element. The deformable arms may protrude at an angle with respect to a plane of the plate element. The deformable arms may protrude upwardly/downwardly from the mounting element at an angle towards the plate element, which may ensure that the displaceable end plate/the deformable arms exhibit the intended deformation characteristic.

According to an embodiment, the displaceable end plate includes two or more plate elements arranged on top of each other (e.g., vertically stacked on each other) such that the plate elements face the cell stack in a common plane. In this embodiment, two or more plate elements may be provided, and each of the plate elements is supported and pressed against the cell stack by its mounting elements and deformable arms as described above. Thus, each of the two or more plate elements may be mounted on opposite sides thereof to the side walls of the cell stack frame via mounting elements of the displaceable end plate, and each mounting element may be connected to the respective plate element via at least two deformable arms allowing for displacement of the displaceable plate element along the stacking axis. The displaceable plate element, under deformation of the deformable arms, exerts a pressure onto the cell stack. All the plate elements may together, in combination, exert pressure onto the cell stack. The plate elements may form, or may be part of, a single plate element. Neighboring plate elements may be distanced from one another via a spacing. Providing multiple such plate elements may allow for uniform pressure to be exerted onto the cell stack and may ensure that the displaceable end plates/the deformable arms exhibit the intended deformation characteristic.

According to an embodiment, a bent connector element is arranged between neighboring plate elements, with the bent connector element interconnecting the neighboring plate elements. The bent connector element is bent backwardly, away from the cell stack, along the stacking axis. For example, the bent connector element is bent backwardly with respect to the common plane of the plate elements. As described, neighboring plate elements may be distanced from one another via a spacing. According to an embodiment, neighboring plate elements are distanced (or spaced apart) from one another by the bent connector elements. The bent connector elements may form a recess or spacing as they are bent backwardly. The bent connector elements may provide stability and flexibility to the displaceable end plate and may ensure that the displaceable end plates/the deformable arms exhibit the intended deformation characteristic.

According to an embodiment, the displaceable end plate including the plate element(s), the deformable arms, and the mounting elements is formed as one-piece from a sheet material. For example, the displaceable end plate may be formed from sheet metal. In other words, the plate element(s), the deformable arms, and the mounting elements may all (e.g., may together) form integral parts of the displaceable end plate. The displaceable end plate may, thus, be formed by processing a single sheet metal, for example, by deep-drawing, bending, folding, and/or cutting the sheet metal. The end plate may be formed without any connectors, such as rivets or screws, and without welding. If multiple plate elements are provided, as described above, the bent connector elements in-between the plate elements may be formed from the same sheet metal as well, for example, by deep-drawing/bending the sheet metal to form the bent connector elements. The sheet metal may be, for example, an aluminum sheet or a (pressed) steel sheet. The displaceable end plate being formed as one piece from a sheet material may provide a simple manufacturing process while providing stability and flexibility to the displaceable end plate and may ensure that the displaceable end plates/the deformable arms exhibit the intended deformation characteristic.

According to an embodiment, each mounting element is connected to the plate element via connecting portions having a thickness at least equal to or thicker than the thickness of the deformable arms. Thus, the connecting portions may be more rigid than the deformable arms, which may prevent the deformable arms from being overly deformed and/or and may ensure that the displaceable end plates/the deformable arms exhibit the intended deformation characteristic.

According to an embodiment, the battery system includes two of the above-discussed displaceable end plates, one at each end (e.g., at opposite ends) of the cell stack frame. For example, the battery system may include a first displaceable end plate at a first end of the cell stack frame and a second displaceable end plate at a second end of the cell stack frame, with the second end being opposite the first end. Both of the two displaceable end plates may be mounted to the side walls as described above. For example, each of the two displaceable end plates may include a plate element facing the cell stack, and the plate element may be mounted on opposite sides thereof to side walls of the cell stack frame via mounting elements of the displaceable end plate. Each mounting element is connected to the plate element via at least two deformable arms allowing for displacement of the plate element along the stacking axis. The plate element, under a deformation of the deformable arms, exerts pressure onto the cell stack. Providing two such displaceable end plates may ensure that the intended pressure is exerted onto the cell stack.

The present disclosure also pertains to an electric vehicle including a battery system as described herein.

According to another embodiment of the present disclosure, a method for assembling a battery system, that is, a battery system as described above, may be provided. Therein, the cell stack frame may be provided without the displaceable end plate placed in its fixture/mounting position. The cell stack may then be inserted into the cell stack frame without pre-compression. Subsequently, the displaceable end plate may be placed in its fixture/mounting position, thereby compressing the cell stack via the plate element(s) and under deformation of the deformable arms.

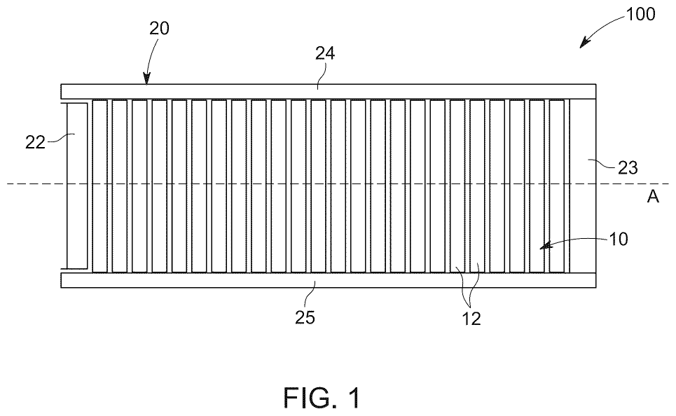

FIG. 1 is a schematic top view of a battery system 100 according to an embodiment. The battery system 100 includes plurality of battery cells 12 arranged to form a cell stack 10 and a cell stack frame 20 accommodating the cell stack 10. The battery cells 12 are stacked (or arranged) along a stacking axis A.

The cell stack frame 20 includes two end plates 22, 23 and two side walls 24, 25 connecting the end plates 22, 23. The end plates 22, 23 and side walls 24, 25 delimit the cell stack 10 from four sides as shown in, for example, FIG. 1. The cell stack frame 20 may further include a top cover and a bottom cover to completely encase the cell stack 10.

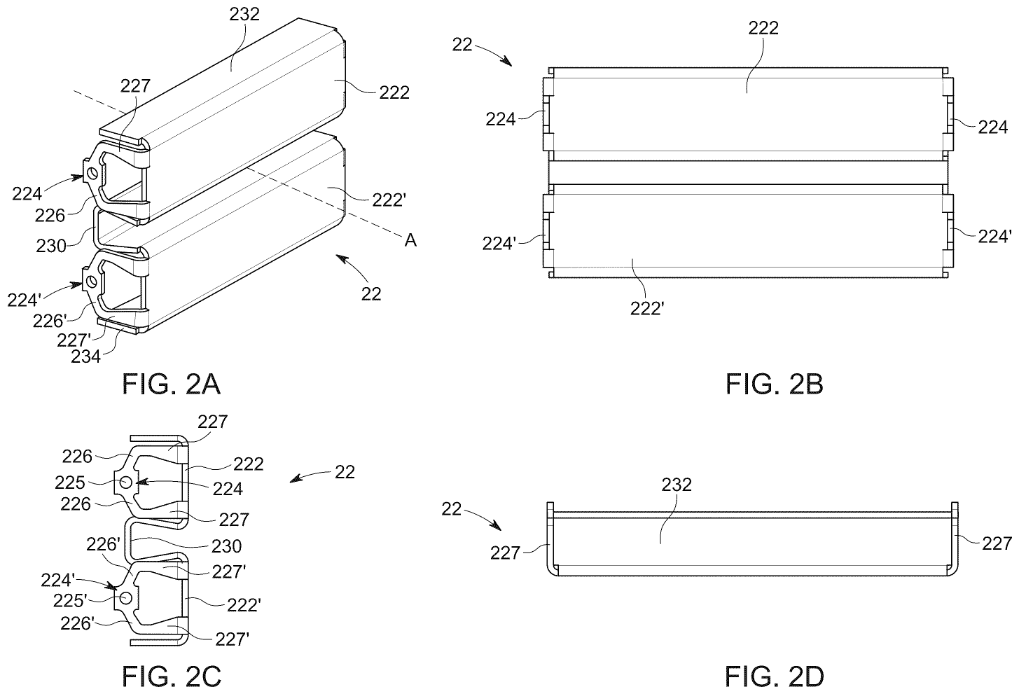

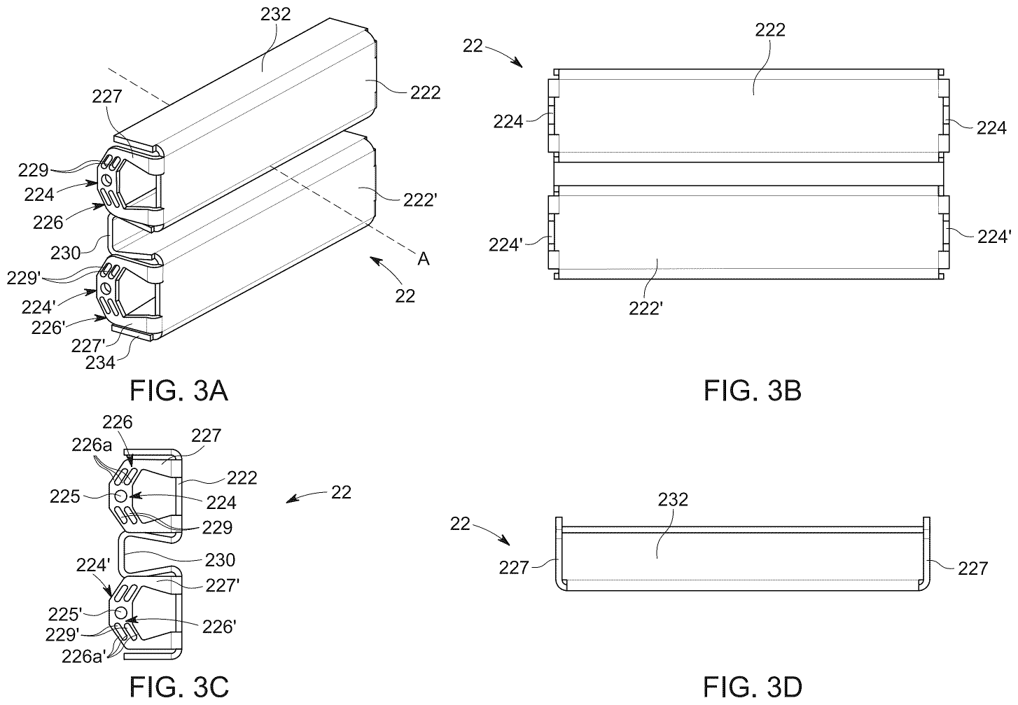

The end plate 22 is a displaceable end plate. Embodiments of the end plate 22 are shown in FIGS. 2A-2D and FIGS. 3A-3D in a perspective (isometric) view, a front view, a top view, a left side view, respectively.

The displaceable end plate 22 includes an upper plate element 222 and a lower plate element 222′. The plate elements 222, 222′ face the cell stack 10 in a common plane (see, e.g., FIGS. 2C and 3C). For example, the plate elements 222, 222′ are arranged above each other (e.g., are vertically stacked on each other).

The upper plate element 222 is mounted, on opposite sides thereof, to the side walls 24, 25 of the cell stack frame 20 via mounting elements 224. Each mounting element 224 may be connected to the upper plate element 222 via two deformable arms 226 and via connecting portions 227. The deformable arms 226 may be connected to the connecting portions 227. One end of the connecting portions 227 may be connected to the plate element 222, and the other end thereof may be connected to the deformable arms 226. The connection portions 227 may have a shape that becomes thinner from the plate element 222 side toward the deformable arms 226 side, and the thinnest portion (e.g., the smallest thickness at the deformable arm 226 side) may be at least equal to or thicker than the thickness of the deformable arm 226. Thus, the connecting portions 227 may be more rigid than the deformable arms 226. This may prevent the deformable arms 226 from being overly deformed. The deformable arms 226 each protrude from the respective mounting element 224 at opposite sides at an angle towards the upper plate element 222. The mounting elements 224 are mounted to the respective side wall 24, 25 via, for example, a bolt or screw inserted into a through-hole 225 in the respective mounting element 224.

The lower plate element 222′ is mounted, on opposite sides thereof, to the side walls 24, 25 of the cell stack frame 20 via mounting elements 224′. Each mounting element 224′ is connected to the lower plate element 222′ via two deformable arms 226′ and via connecting portions 227′. The structure of the connecting portions 227′ and its connection with deformable arms 226′ may be the same as or similar to the structure of connecting portions 227 and the connection between connecting portions 227 and deformable arms 226. The deformable arms 226′ each protrude from the respective mounting element 224′ at opposite sides at an angle towards the lower plate element 222′. The mounting elements 224′ are mounted to the respective side wall 24, 25 via, for example, a bolt or screw inserted into a through-hole 225′ of the respective mounting element 224′.

A bent connector element 230 is arranged between the upper plate element 222 and the lower plate element 222′ that interconnects the neighboring plate elements 222, 222′. The bent connector element 230 is bent backwards, away from the cell stack 10, along the stacking axis A to form a recess. Further, a plate-shaped upper end element 232 extends backwards from the upper plate element 222, for example, at about a 90 degree angle. The upper end element 232, thus, extends in parallel to the stacking axis A. The upper end element 232 may abut the top cover of the cell stack frame 20. A plate-shaped lower end element 234 extends backwards from the lower plate element 222′, for example, at about a 90 degree angle. The lower end element 234, thus, extends in parallel or substantially in parallel to the stacking axis A. The lower end element 232 may abut the bottom cover of the cell stack frame 20.

In the embodiment shown in FIGS. 3A-3D, each of the deformable arms 226, 226′ includes three arm elements 226a, 226a′, and neighboring arm elements 226a, 226a′ are separated from one another by a slit 229, 229′. Other than that, the embodiment of the displaceable end plate 22 shown in FIG. 3 is the same as the embodiment of the displaceable end plate 22 shown in FIG. 2.

The displaceable end plate 22 is formed from a sheet metal, for example, from an aluminum sheet or a pressed steel sheet. For example, the plate elements 222, 222′, the deformable arms 226, 226′ (and, in the embodiment shown in FIG. 3, the arm elements 226a, 226a′), the connecting portions 227, 227′, the mounting elements 224, 224′, and the end elements 232, 234 are formed as one-piece from a sheet metal. For example, a single metal sheet may be deep-drawn and/or bent to form the displaceable end plate/the mentioned elements.

The deformable arms 226, 226′ allow for displacement of the plate elements 222, 222′ along the stacking axis A such that the plate elements 222, 222′, due to deformation of the deformable arms 226, 226′, exert pressure onto the cell stack 10. For example, in the assembled state of the battery system 100 as shown in FIG. 1, the displaceable end plate 22 exerts pressure onto the cell stack 10 via its plate elements 222, 222′ because the plate elements 222, 222′ are pressed against the cell stack 10 via the deformable arms 226, 226′.

Due to production tolerances of the battery cells 12 and possibly of cell spacers (if present) arranged between the battery cells 12, the length of the cell stack 10 may vary. For example, during production, not all produced cell stacks have the same length. Also, the battery cells 12 of the cell stack 10 may swell due to ageing, thereby expanding along the axis A and, thus, increasing the length of the cell stack 10. The cell stack frame 20 and, in particular, the displaceable end plate 22 with its deformable arms 226, 226′ according to embodiments of the present disclosure, may compensate for these different lengths of the cell stack 10.

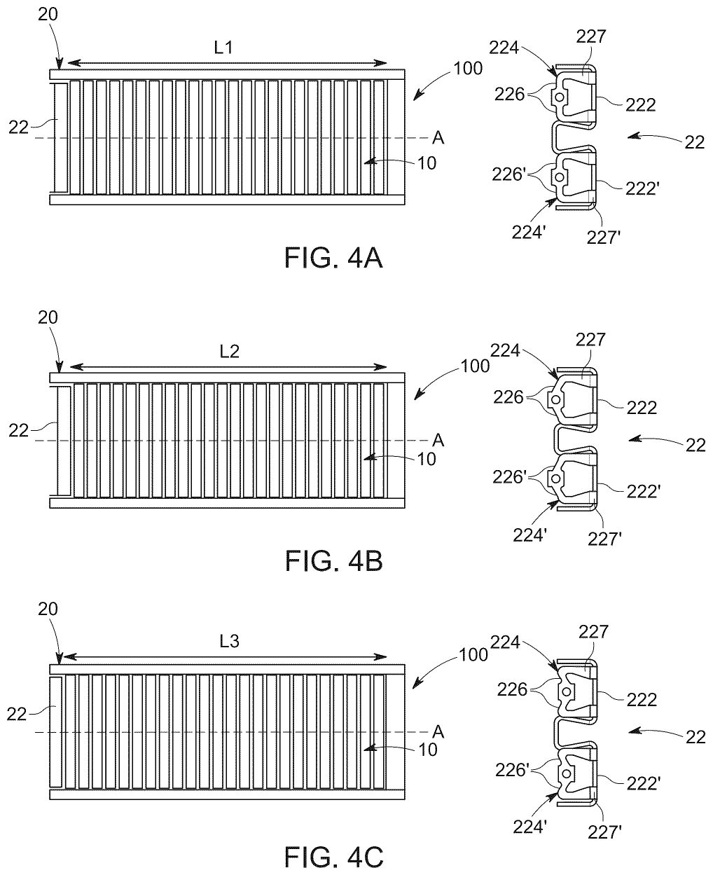

As shown in FIGS. 4A-4C, the deformable arms 226, 226′ of the end plate 22 are deformed to different degrees depending on the cell stack length. In FIG. 4A, the cell stack 10 has a first length L1, in FIG. 4B, the cell stack 10 has a second length L2, and in FIG. 4C, the cell stack 10 has a third length L3. The second length L2 may be a minimal (or smallest) length, the third length L3 a maximum length, and the first length L1 may be a nominal length such that L3>L1>L2. For the cell stack 10 having the minimal length L2, the deformable arms 226, 226′ are only slightly deformed (see, e.g., FIG. 4B). For the cell stack 10 having the maximum length L3, the deformable arms 226, 226′ are heavily (or greatly) deformed (see FIG. 4C). For the cell stack 10 having the nominal length L1, the deformable arms 226, 226′ are moderately deformed (see FIG. 4A). Nevertheless, the displaceable end plate 22 may exert substantially the same pressure via its deformable arms 226, 226′ onto the cell stack 10 independent of the length of the cell stack 10. The cell stack frame 20 with its displaceable end plate 22 may, thus, be configured to ensure the correct pressure conditions for optimal operation of the battery cells 12 over their entire lifetime.

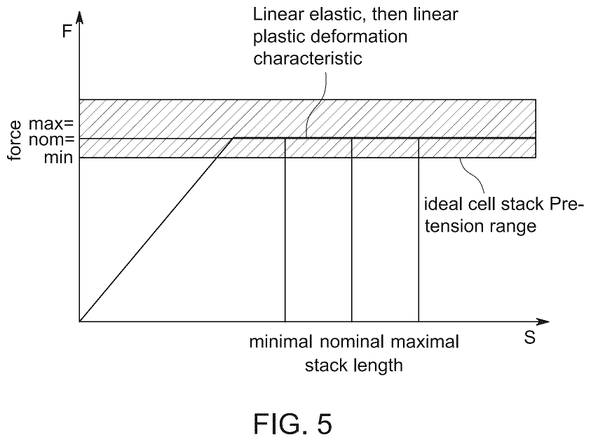

In contrast to conventional battery systems, which may exhibit a rigid linear or progressive elastic pressure characteristic, the displaceable end plate 22, according to embodiments of the present disclosure, has an elastic deformation characteristic at lower compression forces due to its deformable arms 226, 226′ and, at higher compression forces, a plastic deformation characteristic. The plastic deformation characteristic has a flat force-displacement-inclination in the relevant pre-tensioning force range for prismatic or pouch type cells, as shown in FIG. 5.

FIG. 5 is a diagram showing a force F to elongation (e.g., displacement) s ratio for the displaceable end plate 22 including the deformable arms 226, 226′. As shown, the exerted force F increases linearly (e.g., undergoes elastic deformation) with the elongation s (and, thus, stack length L) in a first section at lower forces and stays constant (e.g., undergoes plastic deformation) in a second section at higher forces. The force (and, thus, the pressure) exerted by the displaceable end plate 22 is regulated by the deformable arms 226, 226′ such that the force is maintained within a window or range of an ideal cell stack pre-tension for the different cell stack lengths as shown in, for example, FIGS. 4A-4C.

Thus, the displaceable end plate 22 may, due to the deformable arms 226, 226′, exert a constant compression force onto the cell stack 10 and is, thus, capable of compensating production tolerances as well as swelling forces/displacements of the battery cells 12 over the lifetime of the battery system 100. The displaceable end plate 22 is designed such that the min-max cell stack tolerances are in the flat plateau area of the force/deflection curve as shown in FIG. 5. Thus, the cell stack 10 may be maintained in the optimum range of pressure for peak performance ensuring reliable and safe operation through all its life cycle until end of life.

### SOME REFERENCE SYMBOLS

| | | | |
|---|---|---|---|
| 10 | cell stack | 12 | battery cells |
| 20 | cell stack frame | 22 | displaceable end plate |
| 23 | end plate | 24 | side wall |
| 25 | side wall | 100 | battery system |
| 222 | upper plate element | 222′ | lower plate element |
| 224 | mounting elements | 224′ | mounting elements |
| 225 | through-holes | 225′ | through-holes |
| 226 | deformable arms | 226′ | deformable arms |
| 227 | connecting portions | 227′ | connecting portions |
| 229 | slits | 230 | bent connector element |
| 232 | upper end element | 234 | lower end element |
| A | axis | | |

What is claimed is:

1. A battery system comprising:
a cell stack comprising a plurality of battery cells arranged along a stacking axis; and
a cell stack frame accommodating the cell stack, the cell stack frame comprising:
a displaceable end plate comprising a plate element facing the cell stack and mounting elements at opposite sides of the plate element, the plate element being mounted to side walls of the cell stack frame via the mounting elements,
wherein each of the mounting elements is connected to the plate element via a plurality of deformable arms configured to allow displacement of the plate element along the stacking axis, and
wherein the plate element, under a deformation of the deformable arms, exerts pressure onto the cell stack.

2. The battery system as claimed in claim 1, wherein each of the deformable arms comprises a plurality of arm elements, and
wherein two adjacent ones of the arm elements are separated from one another by a slit.

3. The battery system as claimed in claim 1, wherein, the deformable arms of each of the mounting elements protrude at opposite sides of the corresponding one of the mounting elements.

4. The battery system as claimed in claim 1, wherein the displaceable end plate comprises a plurality of plate elements arranged one above the other, and
wherein the plate elements face the cell stack in a common plane.

5. The battery system as claimed in claim 4, wherein a bent connector element is arranged between neighboring ones of the plate elements to interconnect the neighboring ones of the plate elements, and
wherein the bent connector element is bent backwards away from the cell stack along the stacking axis.

6. The battery system as claimed in claim 1, wherein the plate element, the deformable arms, and the mounting elements of the displaceable end plate are formed as one-piece from a sheet material.

7. The battery system as claimed in claim 6, wherein the displaceable end plate is formed as one-piece from a sheet metal.

8. The battery system as claimed in claim 1, wherein each of the mounting elements is connected to the plate element via connecting portions having a thickness equal to or thicker than a thickness of the deformable arms.

9. The battery system as claimed in claim 1, further comprising two displaceable end plates,
wherein one of the displaceable end plates is at opposite ends of the cell stack frame.

10. An electric vehicle comprising the battery system as claimed in claim 1.
